(19) United States
(12) Patent Application Publication
(10) Pub. No.: US 2026/0266534 A1
(43) Pub. Date: Sep. 10, 2026

(54) DOOR BODY ASSEMBLY AND REFRIGERATION DEVICE

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Zhanwei Liu, Hefei (CN); Bo Xie, Hefei (CN); Jun Li, Hefei (CN)

(21) Appl. No.: 19/161,238

(22) PCT Filed: Nov. 19, 2024
(86) PCT No.: PCT/CN2024/132877

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411187598.X

(51) Int. Cl. F25D 23/02

(52) U.S. Cl. CPC F25D 23/028; F25D 23/021

(57) ABSTRACT

A door body assembly for a refrigeration appliance includes an enclosure door rotatably connected to an appliance main body for opening or closing a storage compartment, a door panel slidably mounted on an outer side of the enclosure door, and a transmission mechanism configured to drive relative movement of the door panel during rotation of the enclosure door. The transmission mechanism enables the door panel to shift laterally as the door is opened or closed, allowing the enclosure door to avoid interference with adjacent cabinet structures. This configuration improves clearance during operation, prevents collisions between the door panel and surrounding objects, and enhances usability across various installation environments.

### CROSS-REFERENCES TO RELATED APPLICATIONS

The present application claims priorities to Chinese Patent Application No. 202323218961.3, filed Nov. 27, 2023, entitled “Refrigerator Hinge”, Chinese Patent Application No. 202410088590.1, filed Jan. 22, 2024, entitled “Door Body Assembly and Refrigeration Device”, and Chinese Patent Application No. 202411187598.X, filed Aug. 26, 2024, entitled “Door Body Assembly and Refrigeration Device”, which are hereby incorporated by reference in their entireties.

### FIELD

The present application relates to the field of home appliances, and in particular to a door body assembly and a refrigeration device.

### BACKGROUND

With the growing demand for the integration of home appliances and home decors, embedded design of home appliances has become a trend.

However, to pursue a better home decor integration effect, it is sometimes necessary to fix and connect a door panel to a surface of a box door, while higher requirements are placed on gaps between embedded appliances and cabinet side walls to further improve the home decor integration effect. If a traditional hinge technology is used after the appliance is embedded in the cabinet, a door body assembly with a door panel may interfere with the side wall of a mounting space inside the cabinet during opening and closing of the door, resulting in the door body assembly of the appliance failing to be opened or closed normally.

### BRIEF SUMMARY

The present application provides a door body assembly and a refrigeration device to solve the problem of a door body assembly with a door panel failing to be opened or closed caused by interference between the door body assembly with the door panel and a side wall of a mounting space inside a cabinet during opening and closing.

A door body assembly of embodiments of the present application includes:
a box door, rotatably connected to an appliance main body, and configured to open or close a storage space of the appliance main body; and
a door panel and a transmission mechanism, where the door panel is slidably provided at an outer side of the box door; the transmission mechanism drives the door panel to move relative to the box door during opening or closing of the box door.

According to the door body assembly of embodiments of the present application, the box door is rotatably connected to the appliance main body, and the door panel is slidably provided at the outer side of the box door, and the box door and the door panel are connected by the transmission mechanism. During opening or closing of the transmission mechanism, the door panel is controlled to move relative to the box door. The box door avoids a side cabinet body during opening and closing, which avoids interference between the door panel and the outside when the box door rotates, and meets the needs of users in different scenarios.

In some embodiments, the door body assembly and the appliance main body are used to be provided in a mounting space formed between a first cabinet body and a second cabinet body; during opening or closing of the box door, the transmission mechanism is configured to drive the door panel to move a preset distance at the box door, and the door panel avoids side walls of the first cabinet body and the second cabinet,
or, the door body assembly and the appliance main body are used to be mounted in a cabinet body; during opening or closing of the box door, the transmission mechanism is configured to drive the door panel to move a preset distance at the box door, and the door panel avoids a side wall of the cabinet body.

In some embodiments, the transmission mechanism includes:
a driver, in transmission connection with the box door;
a driven component, connected to the door panel; and
a transmission component, where the driver is in transmission connection with the driven component through the transmission component, and when the box door drives the driver, the door panel is driven to move along the box door through the driven component.

In some embodiments, the transmission mechanism further includes a transmission pedestal, provided at the box door, with a first guide rail formed at a side and a second guide rail formed at another side, where the first guide rail and the second guide rail are provided in parallel, the driver is slidably provided at the first guide rail, and the driven component is slidably provided at the second guide rail; and
the transmission component includes a first connector and a second connector, where the first connector passes around an end of the transmission pedestal, and is connected to an end of the driver and an end of the driven component at two ends respectively; the second connector passes around another end of the transmission pedestal, and is connected to another end of the driver and another end of the driven component at two ends respectively.

In some embodiments, a side of the transmission pedestal is formed with two opposing first guide rails, and the driver is slidably provided between the two first guide rails;
and/or, another side of the transmission pedestal is formed with two opposing second guide rails, and the driven component is slidably provided between the two second guide rails.

In some embodiments, the driver includes:
a connect rod and a first slider, where an end of the connect rod is rotatably connected to the appliance main body, another end is rotatably connected to the first slider, and the first slider is slidably provided at the first guide rail.

In some embodiments, the driven component includes:
a second slider, where the second slider is slidably provided at the second guide rail, and the second slider is connected to the door panel.

In some embodiments, the driver and/or the driven component are provided with a positioner and a limiter corresponding to the positioner, and the first connector and/or the second connector are connected to the positioner passing through the limiter.

In some embodiments, the door panel assembly further includes a connect mechanism, connected to the door panel; and
one of the second slider and the connect mechanism is formed with a first snap slot, another one is formed with a first snap-fit connector matched with the first snap slot, and the second slider is detachably connected to the connect mechanism through the first snap-fit connector and the first snap slot.

In some embodiments, the second slider is formed with the first slot; and
the connect mechanism includes:
a fix plate, connected to the door panel, and the fix plate is formed with a mounting slot; and
a connect block, slidably provided at the mounting slot, and the connect block is formed with the first snap-fit connector to adjust a relative position between the door panel and the box door by adjusting a position of the connect block in the mounting slot.

In some embodiments, the door body assembly further includes a guide mechanism;
the guide mechanism includes a guide pedestal and a third slider, where the guide pedestal is provided at the box door, the guide pedestal is formed with a third guide rail, the third slider is slidably provided at the third guide rail, and the third slider is connected to the door panel.

In some embodiments, a plurality of the connect mechanisms are provided, one of the third slider and one of the plurality of the connection mechanisms are formed with a second snap slot, the other of the third slider and the connection mechanism is formed with a second snap-fit connector matched with the second snap slot, and the third slider is detachably connected to the connect mechanism through the second snap-fit connector and the second snap slot.

In some embodiments, the box door is provided with a first mounting slot matched with the transmission mechanism, and the transmission mechanism is mounted in the first mounting slot;
and/or, the box door is provided with a second mounting slot matched with the guide mechanism, and the guide mechanism is mounted in the second mounting slot.

In some embodiments, the transmission mechanism further includes: a first shaft and a second shaft;
the transmission component includes a transmission belt, where the transmission belt is sleeved at the first shaft and the second shaft, and the transmission belt includes an upper belt located at a side of the first shaft and the second shaft and a lower belt located at another side of the first shaft and the second shaft, and where the driver is provided at the upper belt, and the driven component is provided at the lower belt.

In some embodiments, the door body assembly includes:
a stroke adjuster, configured to make a stroke of the driver at the upper belt different from a stroke of the driven component at the lower belt.

In some embodiments, the driver includes a first rack, the driven component includes a second rack, and the transmission component includes a transmission gear; and
the first rack is in transmission connection with the box door, the second rack is connected to the door panel, and the transmission gear is provided between the first rack and the second rack, where the transmission gear meshes with the first rack and the second rack, and when the box door drives the first rack to move, the second rack drives the door panel to move in an opposite direction.

A refrigeration device assembly of embodiments of the present application includes:
a box body, formed with a storage space; and
the door body assembly of any of the above embodiments, where the box door is rotatably connected to the box body, and is configured to open or close a storage space of the box body.

The additional aspects and advantages of the present application will be partially presented in the following description, some of which will become apparent from the following description, or learned through practice of the present application.

### BRIEF DESCRIPTION OF THE DRAWINGS

To provide a clearer explanation of the technical solutions in the embodiments of the present application, a brief introduction will be given to the accompanying drawings required for the description of the embodiments. The drawings in the following description are only some embodiments of the present application, and for those skilled in the art, other drawings may be obtained based on these drawings without any creative effort.

FIG. 1 is a first schematic structural sliding diagram of a door body assembly of a refrigeration device according to an embodiment of the present application;

FIG. 2 is schematic structural sliding position diagram of a door body assembly of a refrigeration device according to an embodiment of the present application;

FIG. 3 is a schematic disassembly diagram of a door body assembly according to an embodiment of the present application;

FIG. 4 is a second schematic structural sliding diagram of a door body assembly of a refrigeration device according to an embodiment of the present application;

FIG. 5 is a first schematic structural diagram of a transmission mechanism according to an embodiment of the present application;

FIG. 6 is a second schematic structural diagram of a transmission mechanism according to an embodiment of the present application;

FIG. 7 is a schematic structural diagram of a connect mechanism according to an embodiment of the present application;

FIG. 8 is a first schematic mounting diagram of a connect mechanism according to an embodiment of the present application;

FIG. 9 is a first schematic structural diagram of a guide mechanism according to an embodiment of the present application;

FIG. 10 is a second first schematic structural diagram of a guide mechanism according to an embodiment of the present application;

FIG. 11 is a schematic mounting diagram of a guide mechanism according to an embodiment of the present application;

FIG. 12 is a second schematic mounting diagram of a connect mechanism according to an embodiment of the present application;

FIG. 13 is a first schematic structural diagram of a transmission mechanism according to another embodiment of the present application;

FIG. 14 is a second schematic structural diagram of a transmission mechanism according to another embodiment of the present application;

FIG. 15 is a schematic structural diagram of a door body assembly according to still another embodiment of the present application;

FIG. 16 is a schematic structural diagram of a guide mechanism of a door body assembly according to still another embodiment of the present application;

FIG. 17 is a schematic diagram of an A-A section in FIG. 14; and

FIG. 18 is a schematic structural diagram of a transmission mechanism according to still another embodiment of the present application.

### REFERENCE SIGNS

1: appliance main body; 11: first cabinet body; 12: second cabinet body; 13: cabinet body; 100: mounting space;
2: box door; 21: first mounting slot; 22: second mounting slot;
3: door panel;
4: hinge;
5: transmission mechanism; 51: driver; 511: first slider; 512: connect rod; 513: first pin shaft; 514: fix pedestal; 515: second pin shaft; 516: positioner; 517: limiter; 518: mounting board; 52: passive component; 521: second slider; 522: first snap slot; 53: transmission component; 531: first connector; 532: second connector; 533: upper strap; 534: lower strap; 54: transmission pedestal; 541: first guide rail; 542: second guide rail; 543: first fix block; 544: second fix block; 56: support frame; 57: first shaft; 58: second shaft;
6: guide mechanism; 61: third slider; 611: second snap slot; 62: guide pedestal; 621: third guide rail; 622: third slide;
8: connect mechanism; 81: first snap-fit connector; 82: connect block; 83: fix plate.

### DETAILED DESCRIPTION

Implementations of the present application are further described in detail below in conjunction with accompanying drawings and embodiments. The following embodiments are intended to illustrate the present application, but not to limit the scope of the present application.

In the description of the embodiments of the present application, it is to be noted that the orientation or positional relationships indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing the embodiments of the present application and simplifying the description, rather than indicating or implying that the device or component stated must have a particular orientation, is constructed and operated in a particular orientation, and thus is not to be construed as limiting the embodiments of the present application. Moreover, the terms “first”, “second”, “third”, and the like are used for descriptive purposes only and are not to be construed as indicating or implying relative importance.

In the description of embodiments of the present application, it should be noted that, unless otherwise explicitly specified and defined, the terms “connected to” and “connected” shall be understood broadly. For example, it may be either fixedly connected or detachably connected, or may be integrally connected; it may be either mechanically connected, or electrically connected; it may be either directly connected, or indirectly connected through an intermediate medium. The specific meanings of the terms above in embodiments of the present application may be understood by those skilled in the art in accordance with specific conditions.

In the embodiments of the present application, unless otherwise clearly stated and defined, the first feature being located “on” or “under” the second feature means that the first feature is in direct contact with the second feature or the first feature is in contact with the second feature by an intervening medium. In addition, the first feature is “on”, “above” and “over” the second feature may refer to that the first feature is directly above or obliquely above the second feature, or simply refer to that the level height of the first feature is higher than that of the second feature. The first feature is “under”, “below” and “beneath” the second feature may refer to that the first feature is directly below or obliquely below the second feature, or simply refer to that the level height of the first feature is lower than that of the second feature.

In the description of this specification, descriptions with reference to the terms “one embodiment”, “some embodiments”, “examples”, “specific examples”, or “some examples” etc. mean that specific features, structure, materials or characteristics described in conjunction with the embodiment or example are included in at least one embodiment or example of the embodiments of the present application. In this specification, the schematic expressions of the above terms do not necessarily refer to the same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

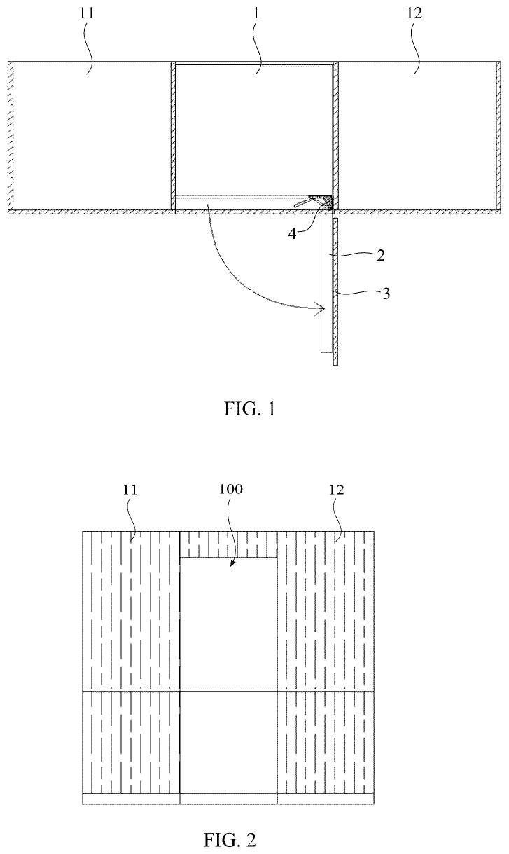

The door body assembly and refrigeration device of the present application will be described below in conjunction with FIG. 1 to FIG. 12. The door body assembly in the present application may be used for home appliances such as refrigerators, but it should be understood that the door body assembly in the present application may also be used for dishwashers, washing machines, or any other suitable devices.

In an embodiment of the present application, as shown in FIG. 1 to FIG. 3, the door body assembly includes: a box door 2, a door panel 3, and a transmission mechanism 5. The box door 2 is rotatably connected to an appliance main body 1 through a hinge 4, and the box door 2 is configured to open or close a storage space of the appliance main body 1; the door panel 3 is slidably provided at an outer side of the box door 2; the transmission mechanism 5 drives the door panel 3 to move relative to the box door 2 during opening or closing of the box door 2.

The specific structure of the transmission mechanism 5 may include transmission parts such as connect rods, gears, and racks, which are connected to the box door 2 and the door panel 3 through appropriate connections (such as bolt connections, and welding, etc.). In this way, when the box door 2 rotates, the transmission mechanism 5 may drive the door panel 3 to move along the box door 2.

In an embodiment, as shown in FIG. 1, during opening of the box door 2, the transmission mechanism 5 drives the door panel 3 to move away from the hinge 4 (to the left relative to the box door 2), which may avoid interference between the door panel 3 and side objects. During closing of the box door 2, the transmission mechanism 5 drives the door panel 3 to move towards the hinge 4 (to the right relative to the box door 2), which may ensure that the door panel 3 avoids side objects during closing.

According to the door body assembly of embodiments of the present application, the box door 2 is rotatably connected to the appliance main body 1, and the door panel 3 is slidably provided at the outer side of the box door 2. The box door 2 and the door panel 3 are connected by the transmission mechanism 5. During opening or closing of the transmission mechanism 5, the door panel 3 is controlled to move relative to the box door 2. The box door 2 avoids the side cabinet body during opening and closing, which may avoid interference between the door panel 3 and the outside when the box door 2 rotates, and may meet the needs of users in different scenarios.

During the movement of the door panel 3 relative to the box door 2, the door panel 3 may move left and right relative to the box door 2, or the door panel 3 may move up and down relative to the box door 2.

A movement relationship between the door panel 3 and the box door 2 needs to be explained in detail. During the movement of the door panel 3 relative to the box door 2, there are two main ways of movement: one is that the door panel 3 may move left and right relative to the box door 2; another one is that the door panel 3 may move up and down relative to the box door 2.

When the door panel 3 moves left and right relative to the box door 2, the door panel 3 will remain unchanged in a vertical direction of the box door 2 and move in a horizontal direction. This means that a position of the door panel 3 will change as it moves left and right at the box door 2, while its vertical distance from the box door 2 remains unchanged.

When the door panel 3 moves up and down relative to the box door 2, the door panel 3 will remain unchanged in the horizontal direction of the box door 2 and move in the vertical direction. This means that the position of the door panel 3 will change as it moves up and down at the box door 2, while its horizontal distance from the box door 2 remains unchanged.

When the door panel 3 moves left and right (or up and down) relative to the box door 2, it does not mean that the only way for the door panel 3 to move is to move left and right (or up and down) relative to the box door 2. In fact, within a certain range of error, the movement of the door panel 3 may be diverse. For example, the door panel 3 may move in the horizontal direction or in the vertical direction relative to the box door 2 within an error range of ±5°.

Furthermore, we need to clarify a relationship between the door panel 3 and the box door 2. The connection between the door panel 3 and the box door 2 is not limited to simple left and right (or up and down) movements, but also includes various other possible relative movements. This type of movements may include slight vibrations, swings, etc., which are beyond the scope of simple left and right (or up and down) movements.

In practical operation, the movement of the door panel 3 cannot be completely precise in the preset direction and distance, and there will always be some errors. Therefore, as long as this error is within an acceptable range, the movement of the door panel 3 may be considered as effective movement.

In addition, the movement of the door panel 3 may also be influenced by external factors such as wind force and vibration, etc. These factors may cause the door panel 3 to make corresponding adjustments within a certain range to maintain its relative position with the box door 2.

In the embodiments of the present application, as shown in FIG. 1 to FIG. 3, the door body assembly and the appliance main body 1 are used to be mounted in the mounting space 100 formed between the first cabinet body 11 and the second cabinet body 12. An outer side of the mounting space 100 is provided with an opening, which allows the door body assembly and the appliance main body 1 to be integrally embedded into the cabinet body. During controlling of the opening or closing of the storage space through the opening of the box door 2, the transmission mechanism 5 is configured to drive the door panel 3 to move a preset distance away from or towards the hinge 4 at the box door 2. The door panel 3 avoids side walls of the first cabinet body 11 and the second cabinet body 12.

During controlling of the opening or closing of the storage space through the opening of the box door 2, the transmission mechanism 5 is configured to drive the door panel 3 to move a preset distance away from or towards the hinge 4 at the box door 2. This design is mainly aimed at avoiding interference between the door panel 3 and the side walls of the first cabinet body 11 and the second cabinet body 12. By moving a preset distance, the door panel 3 may be smoothly opened or closed without colliding or getting stuck with the side walls of the cabinet body.

For example, as shown in FIG. 1 and FIG. 2, during opening of the box door 2, the transmission mechanism 5 drives the door panel 3 to move a preset distance away from the hinge 4 along the box door 2 (relative to the box door 2, moving a preset distance to the left). In this way, the door panel 3 may smoothly avoid the side wall of the second cabinet body 12, allowing the box door 2 to be fully opened, making it convenient for users to access items.

Similarly, during closing of the box door 2, the transmission mechanism 5 drives the door panel 3 to move a preset distance along the box door 2 towards the hinge 4 (relative to the box door 2, moving a preset distance to the right). In this way, the door panel 3 may smoothly avoid the side wall of the first cabinet body 11, allowing the box door 2 to be completely closed, maintaining overall aesthetics and sealing.

This design not only improves the convenience of use, but also avoids possible damage to the door body assembly during use. This design also allows appliances to better integrate into the home furnishing, improving the overall aesthetics of the home furnishing.

In another embodiment, as shown in FIG. 4, the door body assembly and the appliance main body 1 are used to be provided in the cabinet 13; during opening or closing of the box door 3, the transmission mechanism 5 is configured to drive the door panel 3 to move a preset distance at the box door 2. The door panel 3 avoids the side wall of the cabinet 13.

In an embodiment, during opening of the box door 2, the transmission mechanism 5 drives the door panel 3 to move a preset distance away from the hinge 4 along the box door 2 (relative to the box door 2, moving a preset distance to the left). In this way, the door panel 3 may smoothly avoid the side wall at the right side of the cabinet body 13, allowing the box door 2 to be fully opened, making it convenient for users to access items.

Similarly, during closing of the box door 2, the transmission mechanism 5 drives the door panel 3 to move a preset distance along the box door 2 towards the hinge 4 (relative to the box door 2, moving a preset distance to the right). In this way, the door panel 3 may smoothly avoid the left side wall of the cabinet body 13, allowing the box door 2 to be completely closed, maintaining overall aesthetics and sealing.

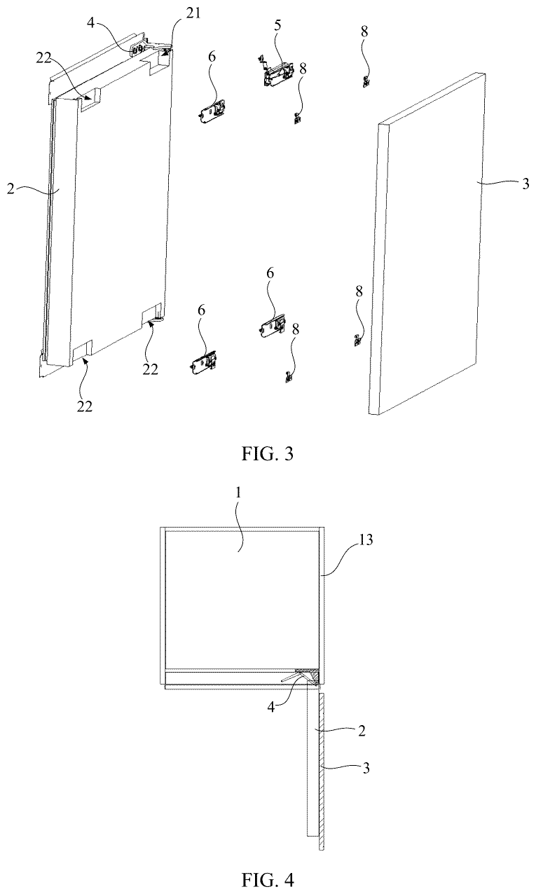

In an embodiment of the present application, as shown in FIG. 3 to FIG. 6, the transmission mechanism 5 includes: a drive component 51, a driven component 52, and a transmission component 53. The driver 51 is in transmission connection with the box door 2, and the driven component 52 is connected to the door panel 3; the driver 51 is in transmission connection with the driven component 52 through the transmission component 53. When the box door 2 drives the driver 51, the door panel 3 is driven to move along the box door 2 towards or away from the hinge 4 through the driven component 52.

In this embodiment, the driver 51 is in transmission connection with the box door 2, which is usually done through rotation or sliding. When the box door 2 is opened or closed, the driver 51 may rotate or move accordingly. This connection may be the meshing of gears and racks, the connection of pulleys and ropes, etc. The specific choice depends on design requirements and available technical conditions.

The driven component 52 is connected to the door panel 3. The door panel 3 may move with the rotation or movement of the driver 51. This connection may be the connection between pulleys and ropes, the connection between shafts and connect rods, etc. The specific choice depends on design requirements and available technical conditions.

The driver 51 is connected to the driven component 52 through the transmission component 53. The transmission component 53 plays a role in transmitting force. When the driver 51 rotates or moves, it may drive the driven component 52 to rotate or move. This type of transmission connection may be the interconnection between parts such as chains, gears, connect rods, and racks, depending on design requirements and available technical conditions.

When the box door 2 is opened or closed, the driver 51 may drive the driven component 52 to move along the box door 2 towards or away from the hinge 4 (moving left and right relative to the box door 2). During this process, the door panel 3 will move along with the movement of the driven component 52, avoiding interference with the cabinet side wall and achieving smooth movement and reliable control of a refrigerator door body.

In a specific embodiment, as shown in FIG. 3 to FIG. 6, the transmission mechanism 5 further includes a transmission pedestal 54. The transmission pedestal 54 is provided at the box door 2 to provide stable support and guidance. The transmission pedestal 54 is formed with a first guide rail 541 at a side, and a second guide rail 542 formed at another side. The first guide rail 541 and the second guide rail 542 at the transmission pedestal 54 are provided in parallel. The driver 51 is slidably provided at the first guide rail 541, and the driven component 52 is slidably provided at the second guide rail 542 to provide stable guidance through the first guide rail 541 and the second guide rail 542.

The transmission component 53 includes a first connector 531 and a second connector 532, where the first connector 531 passes around an end of the transmission pedestal 54, and is connected to an end of the driver 51 and an end of the driven component 52 at two ends respectively; the second connector 532 passes around another end of the transmission pedestal 54, and is connected to another end of the driver 51 and another end of the driven component 52 at two ends respectively.

During working, the transmission mechanism 5 may achieve stable and reliable transmission. During opening or closing of the box door 2, the driver 51 slides at the first guide rail 541, to drive the driven component 52 to slide at the second guide rail 542 through the connection of the first connector 531 and the second connector 532. This design may accurately control the movement trajectory and distance of the door panel 3, avoid interference with the cabinet body side wall, and achieve smooth opening and closing of the box door 2.

In an embodiment, during opening and closing of the door, the change in the angle of the box door 2 will drive the driver 51 to move at the first guide rail 541. The connection between the first connector 531 and the second connector 532 drives the driven component 52 to move in an opposite direction at the second guide rail 542. Due to the connection between the driven component 52 and the door panel 3, the door panel 3 may move at the box door 2, allowing the door panel 3 to avoid the side cabinet.

It should be noted that an edge of a side of the box door 2 is provided with a first mounting slot 21, and the first mounting slot 21 is provided with a plurality of screw holes. Two ends of the transmission pedestal 54 are provided with a first fix block 543 and a second fix block 544. The first fix block 543 and the second fix block 544 have through holes corresponding to the screw holes in the first mounting slot 21. The transmission pedestal 54 may be fixed in the first mounting slot 21 by providing bolts at the first fix block 543 and the second fix block 544.

In an embodiment, as shown in FIG. 3 to FIG. 6, a side of the transmission pedestal 54 is formed with two first guide rails 541 provided vertically opposite each other, and the driver 51 is slidably provided between the two first guide rails 541. The design further enhances the guiding effect to the driver 51, enabling the driver 51 to move more stably along a guide rail direction. By providing two first guide rails 541, the overall stability and reliability of the transmission mechanism 5 are improved, which is conducive to precise control and smooth movement.

Similarly, another side of the transmission pedestal 54 may also be formed with two second guide rails 542 provided vertically opposite each other, and the driven component 52 is slidably provided between the two second guide rails 542. The design enhances the guiding effect to the driven component 52, enabling the driven component 52 to move more stably along the guide rail direction. By providing two second guide rails 542, the stability and reliability of the driven component 52 are improved, further optimizing the motion trajectory and distance control of the door panel 3. This design improves the overall rigidity and stability of the transmission mechanism 5 by increasing a quantity of guide rails, enabling the door body assembly to open and close more smoothly and stably.

In some embodiments, as shown in FIG. 3 to FIG. 6, the driver 51 includes: a connect rod 512 and a first slider 511. An end of the connect rod 512 is rotatably connected to the hinge 4 or hinged to the appliance main body 1, and another end of the connect rod 512 is rotatably connected to the first slider 511, where the first slider 511 is slidably provided at the first guide rail 541.

In this embodiment, an end of the connect rod 512 is hinged to the fix pedestal 514 through a first pin shaft 513, and another end of the connect rod 512 is hinged to a mounting plate 518 at the first slider 511 through a second pin shaft 515. The fix pedestal 514 is fixed in screw holes at the hinge 4 by screws. When the box door 2 rotates, the connect rod 512 correspondingly rotates to drive the first slider 511 to move at the first guide rail 541. The connection between a first connector 531 and a second connector 532 drives the driven component 52 to move in an opposite direction at the second guide rail 542. Due to the connection between the driven component 52 and the door panel 3, the door panel 3 may move at the box door 2. The stable movement of the driver 51 is achieved through the slide connection between the first slider 511 and the first guide rail 541.

Correspondingly, the driven component 52 includes a second slider 521. The second slider 521 is slidably provided at the second guide rail 542, and the second slider 521 is connected to the door panel 3. Under driving of the first connector 531 and the second connector 532, the second slider 521 may move at the second guide rail 542 to drive the door panel 3 to move. The stable movement of the driven component 52 is achieved through the slide connection between the second slider 521 and the second guide rail 542.

In addition, requirements in practical applications are considered. Ends at two sides of the first guide rail 541 and the second guide rail 542 may also be provided with a limit structure. By limiting of the limit structure, the first slider 511 and the second slider 521 may move within a preset range of motion, to provide a movement distance according to the needs and meet the requirements of different occasions.

In practical applications, providing of the limit structure enables the first slider 511 and the second slider 521 to move within the preset range of motion. This design fully meets the movement distance provided according to different needs. The first slider 511 and the second slider 521 may reach a preset position during movement and stop when reaching a limit position, avoiding damage or safety hazards caused by excessive movement. In addition, this limit structure may conveniently control the first slider 511 and the second slider 521. By providing different limit points, precise control of the slider movement may be achieved, enabling precise control of the movement distance of the door panel 3, and meeting the needs of various application scenarios.

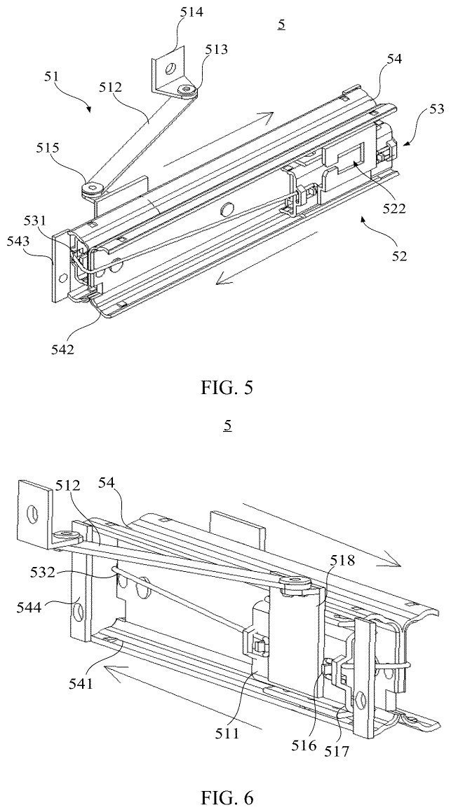

In an embodiment, as shown in FIG. 5 and FIG. 6, the driver 51 and/or the driven component 52 are provided with a positioner 516 and a limiter 517 corresponding to the positioner 516, and the first connector 531 and/or the second connector 532 are connected to the positioner 516 passing through the limiter 517.

In a specific embodiment, the positioner 516 may be selected as a column, which is vertically provided at the first slider 511 and the second slider 521, while the limiter 517 may be selected as an arch-shaped rib. Two sides of the first slider 511 of the driver 51 are provided with two columns and corresponding arch-shaped ribs. Two sides of the second slider 521 of the driven component 52 are provided with two columns and corresponding arch-shaped ribs. An end of the first connector 531 passes through one of the arch-shaped ribs of the first slider 511 and is wrapped around the corresponding column, and another end of the first connector 531 passes through one of the arch-shaped ribs of the second slider 521 and is wrapped around the corresponding column. An end of the second connector 532 passes through another one of the arch-shaped ribs of the first slider 511 and is wrapped around the corresponding column. Another end of the second connector 532 passes through another one of the arch-shaped ribs of the first slider 511 and is wrapped around the corresponding column. Through the match among the first connector 531, the second connector 532, the column, and the arch-shaped rib, not only is the connection between the first slider 511 and the second slider 521 achieved, but the limit of the arch-shaped rib also facilitates the force transmission between the first slider 511 and the second slider 521.

In an example, as shown in FIG. 3 and FIG. 7, the door panel assembly further includes a connect mechanism 8, where the connect mechanism 8 is connected to the door panel 3, and the connect mechanism 8 may be an independent part or a part of the door panel 3. One of the second slider 521 and the connect mechanism 8 is formed with a first snap slot 522, another one is formed with a first snap-fit connector 81 matched with the first snap slot 522, and the second slider 521 is detachably connected to the connect mechanism 8 through the first snap-fit connector 81 and the first snap slot 522.

In this embodiment, the second slider 521 is provided with a first snap slot 522, where a side of the first snap slot 522 is provided with a notch. The connect mechanism 8 is provided with the first snap-fit connector 81, and the first snap-fit connector 81 may pass the notch and be fixed in the first snap slot 522. Since the connect mechanism 8 is connected to the door panel 3, the connection between the second slider 521 and the door panel 3 may be achieved through the connection between the first snap-fit connector 81 and the first snap slot 522.

Through this detachable connection, the connection between the second slider 521 and the connect mechanism 8 is more flexible and convenient. Actual needs may be considered to determine whether to mount the connect mechanism 8, and an appropriate connection chose based on different usage scenarios. This design improves the versatility and adaptability of the door body assembly, while simplifying the manufacturing and assembly, and reducing production and maintenance costs.

In another embodiment, as shown in FIG. 3 and FIG. 7, the second slider 522 is formed with the first slot 521. The connect mechanism 8 includes: a fix plate 83 and a connect block 82. The fix plate 83 is connected to the door panel 3, providing additional structural support for the door panel 3, and the fix plate 83 is formed with a mounting slot to accommodate the connect block 82; the connect block 82 is slidably provided in the mounting slot, and the first snap-fit connector 81 is formed at the connect block 82 to adjust a relative position between the door panel 3 and the box door 2 by adjusting a position of the connect block 82 in the mounting slot. Through this adjustable design, users may adjust the position of the door panel 3 according to actual needs to meet the needs of different usage scenarios.

In an embodiment, the first snap-fit connector 81 is a U-shaped downward hook that may slide into the first snap slot 522 through the notch. The connect block 82 is provided with a first rectangular hole extending in an up-down direction. The fix plate 83 is provided with two mounting holes, and a mounting slot located between the two mounting holes extending left and right. A side wall of the mounting slot is provided with a second rectangular hole extending in a left-right direction. The connect block 82 may slide in the mounting slot. By controlling a position of the connect block 82 in the mounting slot, the connect block 82 may move up and down relative to the fix plate 83. Screws may be provided to pass through the first rectangular hole at the mounting slot and the second rectangular hole at the connect block 82, forming a connect block 82 that may be adjusted in both the up-down direction and the left-right direction. By fixing the relative position of the mounting holes of the fix plate 83 and the door panel 3, positions of the fix plate 83 and the door panel 3 may be adjusted in the up-down direction and the left-right direction.

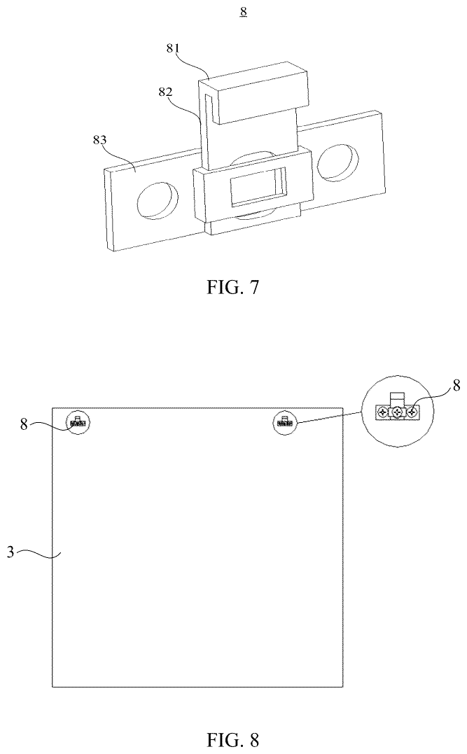

As shown in FIG. 7 and FIG. 8, mounting of the connect mechanism 8 and the door panel 3 matched with the transmission mechanism 5 is as follows.

The connect block 82 is inserted into the mounting slot of the fix plate 83. Screws are used to pass through the second rectangular hole, the first rectangular hole, and the door panel 3, and the connect mechanism 8 is connected as a whole to the door panel 3. The first snap-fit connector 81 at the connected connect block 82 is hanged in the first snap slot 522 to complete the connection between the connect block 82 and the second slider 521. Then, by observing a positional relationship between the door panel 3 and the box door 2, deviations (if any) are checked. If there is a deviation, a position may be adjusted through the first rectangular hole and the second rectangular hole. When the deviation is large, the screw may be removed to separate the connect mechanism 8 from the door panel 3 and adjust the position of the connect mechanism 8. The position of the connect block 82 is adjusted by the door panel 3, fix plate, and the connect block assembly. If the positional relationship meets a requirement and no adjustment is needed, screws are used to pass through the mounting holes at two sides of the fix plate 83 and the door panel 3, further fixing the door panel 3 and the fix plate 83 to maintain a stable position. By using the above method, not only may the position of the connect mechanism 8 be fine tuned, but it may also ensure that all fixing is firm and the positional relationship between the door panel 3 and the box door 2 is accurate and correct.

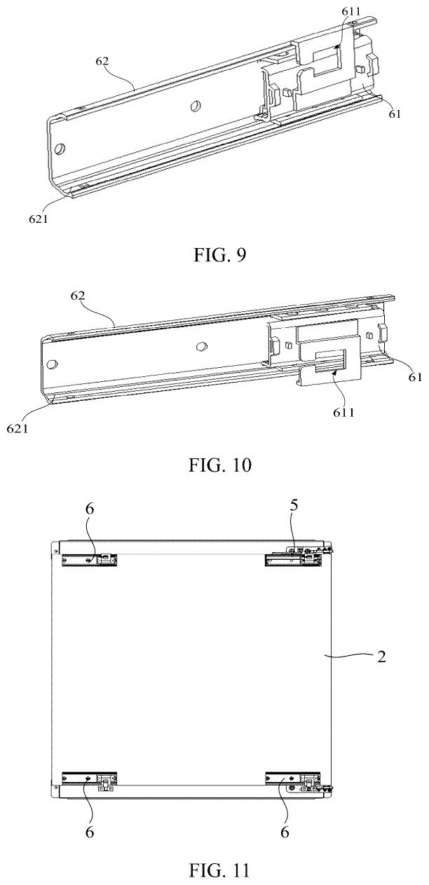

In an embodiment, as shown in FIG. 3 and FIG. 9, the door body assembly further includes a guidance mechanism 6; the guide mechanism 6 includes a guide pedestal 62 and a third slider 61. The guide pedestal 62 is provided at the box door 2. The guide pedestal 62 is formed with a third guide rail 621. The third slider 61 is slidably provided at the third guide rail 621, and the third slider 61 is connected to the door panel 3.

The third slider 61 is connected to the door panel 3, and this connection may be selected according to actual needs, such as through screws, welding, and buckles, etc. Through this connection, when the door panel 3 slides relative to the box door 2, the door panel 3 may push the third slider 61 to slide at the third guide rail 621, which may greatly increase the stability of the relative sliding between the door panel 3 and the box door 2.

In addition, by the design of the third guide rail 621, such as providing a limit structure at the end of the third guide rail 621, a movement distance of the door panel 3 may be adjusted according to actual needs to meet the needs of different users.

The box door 2 is provided with the first mounting slot 21 matched with the transmission mechanism 5, and the transmission mechanism 5 is mounted in the first mounting slot 21; and/or, the box door 2 is provided with a second mounting slot 22 matched with the guide mechanism 6, and the guide mechanism 6 is mounted in the second mounting slot 22.

Inside the box door 2, a first mounting slot 21 matched with the transmission mechanism 5 is provided, allowing the transmission mechanism 5 to be smoothly mounted in the first mounting slot 21. This design allows the box door 2 to form a stable match with transmission mechanism 5 during opening and closing, reducing an overall thickness of the box door 2 and the door panel 3.

In addition, the box door 2 is also provided with the second mounting slot 22 matched with the guide mechanism 6. A function of the guide mechanism 6 is to provide stable guidance during the movement of the box door 2, avoiding a phenomenon of shaking or deviation from a track when the box door 2 is opened and closed. By mounting the guide mechanism 6 in the second mounting slot 22, the stability and accuracy of the box door 2 during movement may be ensured, and the overall thickness of the box door 2 and the door panel 3 may be reduced.

In general, a side of the guide base 62 is formed with two third guide rails 621 provided vertically opposite each other, and the third slider 61 is slidably provided between the two third guide rails 621. The guiding effect of the third slider 61 is enhanced, enabling the third slider 61 to move more stably along the guide rail direction. By providing two third guide rails 621, the overall stability and reliability during guidance are improved, which is conducive to precise control and smooth movement.

To achieve the fixation of the guide mechanism 6, a plurality of the connect mechanisms 8 are provided. The third slider 61 and one of the connect mechanisms 8 are formed with a second snap slot 611, another one of the connect mechanisms 8 is formed with a second snap-fit connector matched with the second snap slot 611, and the third slider is detachably connected to the connect mechanism 8 through the second snap-fit connector and the second snap slot 611.

In this embodiment, the third slider 61 is provided with the second snap slot 611, and a side of the second snap slot 611 is provided with a notch. The connect mechanism 8 is provided with the second snap-fit connector, and the second snap-fit connector may be fixed in the second snap slot 611 through the notch. Since the connect mechanism 8 is connected to the door panel 3, the connection between the third slider 61 and the door panel 3 may be achieved through the connection between the second snap-fit connector and the second snap slot 611.

Through this detachable connection, the connection between the third slider 61 and the connect mechanism 8 is more flexible and convenient. Actual needs may be considered to determine whether to mount the connect mechanism 8, and an appropriate connection chose based on different usage scenarios. This design improves the versatility and adaptability of the door body assembly, while simplifying the manufacturing and assembly, and reducing production and maintenance costs.

In this embodiment, a structure of the first snap-fit connector 81 is the same as a structure of the second snap-fit connector, that is, the connect mechanism 8 used to connect the second slider 521 is the same as the connect mechanism used to connect the third slider 61. As shown in FIG. 7, the connect mechanism 8 includes: a fix plate 83 and a connect block 82. The fix plate 83 is connected to the door panel 3, providing additional structural support for the door panel 3, and the fix plate 83 is formed with a mounting slot to accommodate the connect block 82; the connect block 82 is slidably provided in the mounting slot, and the first snap-fit connector 81 is formed at the connect block 82 to adjust a relative position between the door panel 3 and the box door 2 by adjusting a position of the connect block 82 in the mounting slot. Through this adjustable design, users may adjust the position of the door panel 3 according to actual needs to meet the needs of different usage scenarios.

In an embodiment, the second snap-fit connector is a U-shaped downward hook that may slide into the second snap slot 611 through the notch. The connect block 82 is provided with a first rectangular hole extending in an up-down direction. The fix plate 83 is provided with two mounting holes, and a mounting slot located between the two mounting holes extending left and right. A side wall of the mounting slot is provided with a second rectangular hole extending in a left-right direction. The connect block 82 may slide in the mounting slot. By controlling a position of the connect block 82 in the mounting slot, the connect block 82 may move up and down relative to the fix plate 83. Screws may be provided to pass through the first rectangular hole at the mounting slot and the second rectangular hole at the connect block 82, forming a connect block 82 that may be adjusted in both the up-down direction and the left-right direction. By fixing the relative position of the mounting holes of the fix plate 83 and the door panel 3, positions of the fix plate 83 and the door panel 3 may be adjusted in the up-down direction and the left-right direction.

As shown in FIG. 7 to FIG. 9, mounting of the connect mechanism 8 and the door panel 3 matched with the guide mechanism 6 is as follows.

The connect block 82 is inserted into the mounting slot of the fix plate 83. Screws are used to pass through the second rectangular hole, the first rectangular hole, and the door panel 3, and the connect mechanism 8 is connected as a whole to the door panel 3. The second snap-fit connector at the connected connect block 82 is hanged in the second snap slot 611 to complete the connection between the connect block 82 and the third slider 61. Then, by observing a positional relationship between the door panel 3 and the box door 2, deviations (if any) are checked. If there is a deviation, a position may be adjusted through the first rectangular hole and the second rectangular hole. When the deviation is large, the screw may be removed to separate the connect mechanism 8 from the door panel 3 and adjust the position of the connect mechanism 8. The position of the connect block 82 is adjusted by the door panel 3, fix plate, and the connect block assembly. If the positional relationship meets a requirement and no adjustment is needed, screws are used to pass through the mounting holes at two sides of the fix plate 83 and the door panel 3, further fixing the door panel 3 and the fix plate 83 to maintain a stable position.

In some embodiments, as shown in FIG. 3, a plurality of the guide mechanisms 6 are provided. To match with the guidance, the third guide rail 621 in each guide mechanism 6 is provided parallel to the first guide rail 541 and the second guide rail 542 at the transmission mechanism 5. This parallel design ensures that the door panel 3 may receive accurate guidance during movement, avoiding interference with the side wall of the cabinet body. Through the match of the guide mechanism 6 and the transmission mechanism 5, smooth and stable movement of the door panel 3 may be achieved, improving the convenience and reliability of use.

This design may be adjusted and optimized according to actual needs, such as changing a quantity, position, and size of the guide mechanism 6, as well as adjusting the parallelism of the third guide rail 621 with the first guide rail 541 and the second guide rail 542. These adjustment may be made according to specific usage scenarios to achieve optimal performance and user experience.

In an embodiment, as shown in FIG. 3, and FIG. 9 to FIG. 11, the box door 2 is provided with one first mounting slot 21 and three second mounting slots 22. The first mounting slot 21 is provided at a top of a right side of the box door 2, and one of the second mounting slots 22 is correspondingly provided at the top of a left side of the box door 2. The other two second mounting slots 22 are respectively provided at left and right sides of a bottom of the box door 2. Correspondingly, the door body assembly is provided with one transmission mechanism 5 and three guide mechanisms 6. The transmission mechanism 5 is mounted in the first mounting slot 21, and another three guide mechanisms 6 are respectively provided in the three second mounting slots 22. One of the three guide mechanisms 6 is a top guide mechanism, as shown in FIG. 9. The other two guide mechanisms 6 are bottom guide mechanisms, as shown in FIG. 10. A structure of the top guide mechanism 6 is the same as a structure of the bottom guide mechanism 6, and they are symmetrically provided.

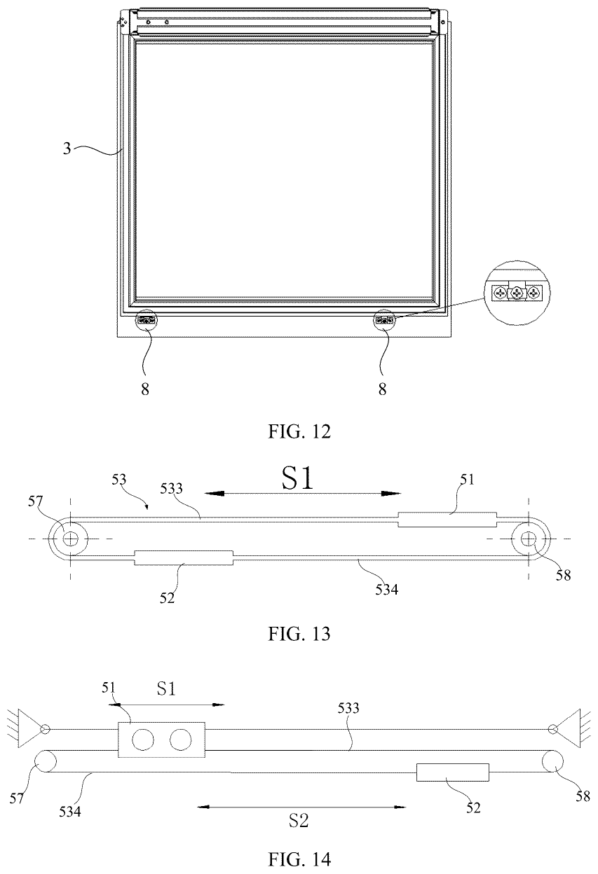

As shown in FIG. 8 and FIG. 12, four connect mechanisms 8 are provided, corresponding to one transmission mechanism 5 and three guide mechanisms 6, respectively. The connection is to fix the connect mechanism 8 and the door plate 3 through the first rectangular hole and the second rectangular hole, connect the connect mechanism 8 with the corresponding slider, adjust the box door 2 and the door plate 3, and then use screws to pass through the mounting holes at two sides of the fix plate 83 and the door plate 3, further fixing the door plate 3 and the fix plate 83. The specific process may refer to the above examples, and will not be repeated here.

As shown in FIG. 1 and FIG. 2, when the box door 2 is opened, the transmission mechanism 5 drives the door panel 3 to move a preset distance away from the hinge 4 along the box door 2. During this process, the door panel 3 moves outward under the limitation of the three guide mechanisms 6. In this way, the door panel 3 may smoothly avoid the side wall of the second cabinet body 12 and ensure stability during movement, allowing the box door 2 to be fully opened and facilitating user access to items. Similarly, when the box door 2 is closed, the transmission mechanism 5 drives the door panel 3 to move a preset distance along the box door 2 towards the hinge 4. During this process, the door panel 3 moves inward under the limitation of the three guide mechanisms 6. In this way, the door panel 3 may smoothly avoid the side wall of the first cabinet body 11, allowing the box door 2 to be completely closed, maintaining overall aesthetics and sealing.

In some embodiments, as shown in FIG. 13 and FIG. 14, the transmission mechanism 5 further includes: a first shaft 57 and a second shaft 58. The transmission component 53 includes a transmission belt, where the transmission belt is sleeved at the first shaft 57 and the second shaft 58. The transmission belt includes an upper belt 533 located at a side of the first shaft 57 and the second shaft 58 and a lower belt 534 located at another side of the first shaft and the second shaft. The driver 51 is provided at the upper belt 533, and the driven component 52 is provided at the lower belt 534.

In this embodiment, the first shaft 57 and the second shaft 58 are used for support and transmission, ensuring stable movement of the driver 51, the driven component 52, and the transmission component 53. The transmission component 53 adopts the form of a transmission belt, which has high flexibility and may adapt to different motion trajectories and distance requirements. The transmission belt is sleeved at the first shaft 57 and the second shaft 58, and the tension and movement of the transmission belt are achieved by the rotation of these two shafts.

The driver 51 is provided at the upper belt 533. During the rotation of the box door 2, the driver 51 drives the upper belt 533 to move in a first direction, and the lower belt 534 moves in a second direction under the traction of the upper belt 533. As the driven component 52 is provided at the lower belt 534 and connected to the door panel 3, the relative sliding between the door panel 3 and the box door 2 may be controlled under the traction of the lower belt 534.

In an embodiment, as shown in FIG. 1 and FIG. 2, during opening of the box door 2, the driver 51 drives the upper belt 533 to move inward, while the lower belt 534 drives the door panel 3 to move a preset distance away from the hinge 4 along the box door 2 through the driven component 52. In this way, the door panel 3 may smoothly avoid the side wall of the second cabinet body 12, allowing the box door 2 to be fully opened, making it convenient for users to access items.

Similarly, during closing of the box door 2, the driver 51 drives the upper belt 533 to move outward, while the lower belt 534 drives the door panel 3 to move a preset distance along the box door 2 towards the hinge 4 through the driven component 52. In this way, the door panel 3 may smoothly avoid the side wall of the second cabinet body 12, allowing the box door 2 to be completely closed.

In addition, by adjusting a position and angle of the first shaft 57 and the second shaft 58, the motion trajectory and distance of the transmission belt may also be adjusted according to actual needs to meet the needs of different users.

Strokes of the driver 51 and the driven component 52 are changed to adapt to different user needs. The door body assembly further includes a stroke adjuster. The stroke adjuster is configured to make a stroke of the driver 51 at the upper belt 533 different from a stroke of the driven component 52 at the lower belt 534.

The stroke adjuster may be provided as a pulley group or a movable pulley as needed, to change strokes of the driver 51 and the driven component 52. For example, the stroke of the driver 51 may be reduced to increase the stroke of the driven component 52, to solve the interference problem caused by insufficient displacement of the door panel 3 in small angles.

In this embodiment, to increase the displacement of the door panel 3, the stroke adjuster reduces its stroke with the upper belt 533. A displacement of the driven component 52 at the lower belt 534 is twice a displacement of the driver 51, increasing the displacement of the door panel 3 at the box door 2. In addition, through the design of the stroke adjuster, the movement trajectory of the door panel 3 may be adjusted according to actual needs to meet the needs of different users.

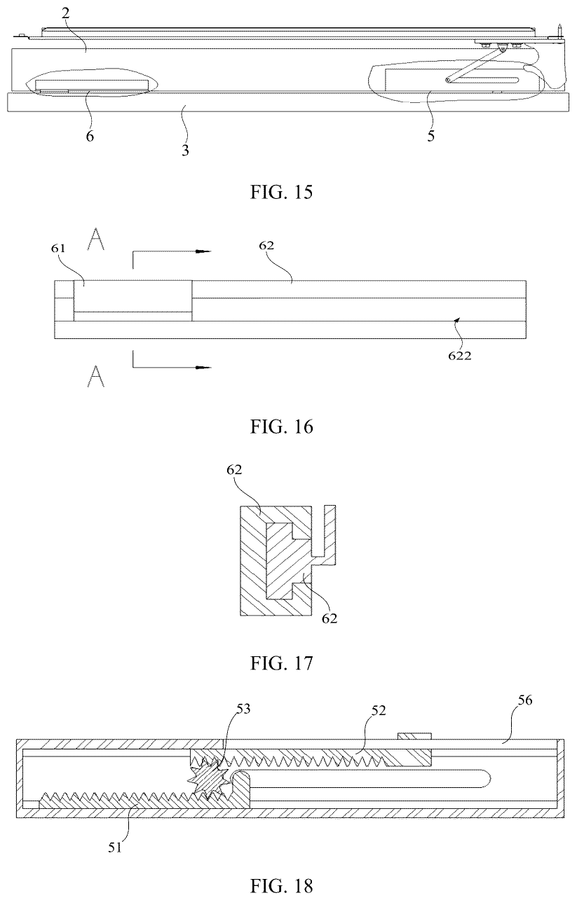

In an embodiment, as shown in FIG. 15 to FIG. 18, the driver 51 includes a first rack, the driven component 52 includes a second rack, and the transmission component 53 includes a transmission gear; the first rack is in transmission connection with the box door 2, the second rack is connected to the door panel 3, and the transmission gear is provided between the first rack and the second rack, where the transmission gear meshes with the first rack and the second rack. When the box door 2 drives the first rack to move, the second rack drives the door panel 3 to move in an opposite direction.

In an embodiment, both the first rack and the second rack are provided at a support frame 56, where the support frame 56 is formed with a first slide for the first rack to move and a second slide for the second rack to move. The transmission gear is provided between the first rack and the second rack. The first rack is connected to the box door 2 through a connect rod. During the rotation of the box door 2, the first rack may be pushed to move along the first slide in the first direction. Through the reversal of the transmission gear, the second rack moves along the second slide in the second direction, allowing the first rack and the second rack to move in different directions and control the relative sliding between the door panel 3 and the box door 2.

In an embodiment, as shown in FIG. 1 and FIG. 2, during opening of the box door 2, the box door 2 drives the first rack to move inward. Under the reversal of the transmission gear, the second rack drives the door panel 3 to move a preset distance away from the hinge 4 along the box door 2. In this way, the door panel 3 may smoothly avoid the side wall of the second cabinet body 12, allowing the box door 2 to be fully opened, making it convenient for users to access items.

Similarly, during closing of the box door 2, the box door 2 drives the first rack to move outward. Under the reversal of the transmission gear, the second rack drives the door panel 3 to move a preset distance along the box door 2 towards the hinge 4. In this way, the door panel 3 may smoothly avoid the side wall of the second cabinet body 12, allowing the box door 2 to be completely closed.

As shown in FIGS. 16 and 17, in this embodiment, the door body assembly further includes the guidance mechanism 6; the guide mechanism 6 includes the guide pedestal 62 and the third slider 61. The guide pedestal 62 is provided at the box door 2, and a third slide 622 is formed at the guide pedestal 62. The third slider 61 is slidably provided at the third slide 622, and the third slider 61 is connected to the door panel 3. The third slider 61 is connected to the door panel 3, and this connection may be selected according to actual needs, such as through screws, welding, and buckles, etc. Through this connection, when the door panel 3 slides relative to the box door 2, the door panel 3 may push the third slider 61 to slide at the third slide 622, which may greatly increase the stability of the relative sliding between the door panel 3 and the box door 2.

In another embodiment of the present application, a refrigeration device is provided. The refrigeration device is provided with a box body and a door body assembly. The door body assembly include: a box door 2, a door panel 3, and a transmission mechanism 5. The box boxy is formed with a storage space; the box door 2 is connected to the box body through a hinge 4, and the box door 2 is configured to open or close the storage space of the box body; the door panel 3 is slidably provided at an outside of the box door 2, and the transmission mechanism 5 drives the door panel 3 to move relative to the box door 2 during opening or closing of the box door 2.

During opening of the box door 2, the transmission mechanism 5 drives the door panel 3 to move away from the hinge 4 (to the left relative to the box door 2), which may avoid interference between the door panel 3 and side objects. During closing of the box door 2, the transmission mechanism 5 drives the door panel 3 to move towards the hinge 4 (to the right relative to the box door 2), which may ensure that the door panel 3 avoids side objects during closing.

The combination of the door panel 2 and the door panel 3 enables the refrigeration device to avoid interference between the door panel 3 and surrounding objects when opening and closing, greatly improving the convenience of use. Especially in narrow kitchen environments, this design advantage is even more pronounced. In addition, the providing of the transmission mechanism 5 enables the door panel 3 to move smoothly during opening and closing, improving the service life and stability of the refrigerator.

The refrigeration device in the present application is applied, for example, as a refrigerator, but it should be understood that the refrigeration device in the present application may also be applied as a freezer or any other suitable devices, without limitation.

It may be understood that the door body assembly has the beneficial effects of the above embodiments, the refrigeration device will correspondingly have the beneficial effects of the above embodiments. The specific implementation may refer to the above embodiments, and the present application will not repeat it.

Finally, it should be noted that the above embodiments are only used to illustrate the present application and not to limit it. Although the present application has been described in detail with reference to the embodiments, those skilled in the art should understand that various combinations, modifications, or equivalent substitutions of the technical solution of the present application do not depart from the scope of the technical solution of the present application, and should be included in the scope of the claims of the present application.

1. A door body assembly, comprising:
a box door, rotatably connected to an appliance main body, and configured to open or close a storage space of the appliance main body; and
a door panel and a transmission mechanism, wherein the door panel is slidably provided at an outer side of the box door; the transmission mechanism drives the door panel to move relative to the box door during opening or closing of the box door.

2. The door body assembly of claim 1, wherein the door body assembly and the appliance main body are used to be provided in a mounting space formed between a first cabinet body and a second cabinet body; during opening or closing of the box door, the transmission mechanism is configured to drive the door panel to move a preset distance at the box door, and the door panel avoids side walls of the first cabinet body and the second cabinet body.

3. The door body assembly of claim 2, wherein the transmission mechanism comprises:
a driver, in transmission connection with the box door;
a driven component, connected to the door panel; and
a transmission component, wherein the driver is in transmission connection with the driven component through the transmission component, and when the box door drives the driver, the door panel is driven to move along the box door through the driven component.

4. The door body assembly of claim 3, wherein the transmission mechanism further comprises a transmission pedestal provided at the box door, with a first guide rail formed at a side and a second guide rail formed at another side, and wherein the first guide rail and the second guide rail are provided in parallel, the driver is slidably provided at the first guide rail, and the driven component is slidably provided at the second guide rail; and
the transmission component comprises a first connector and a second connector, wherein the first connector passes around an end of the transmission pedestal, and is connected to an end of the driver and an end of the driven component at two ends respectively; the second connector passes around another end of the transmission pedestal, and is connected to another end of the driver and another end of the driven component at two ends respectively.

5. The door body assembly of claim 4, wherein a side of the transmission pedestal is formed with two opposing first guide rails, and the driver is slidably provided between the two first guide rails;
and/or, another side of the transmission pedestal is formed with two opposing second guide rails, and the driven component is slidably provided between the two second guide rails.

6. The door body assembly of claim 4, wherein the driver comprises:
a connect rod and a first slider, wherein a first end of the connect rod is rotatably connected to the appliance main body, a second end is rotatably connected to the first slider, and the first slider is slidably provided at the first guide rail.

7. The door body assembly of claim 4, wherein the driven component comprises:
a second slider, wherein the second slider is slidably provided at the second guide rail, and the second slider is connected to the door panel.

8. The door body assembly of claim 4, wherein the driver and/or the driven component are provided with a positioner and a limiter corresponding to the positioner, and the first connector and/or the second connector are connected to the positioner passing through the limiter.

9. The door body assembly of claim 7, wherein the door body assembly further comprises a connect mechanism, connected to the door panel; and
one of the second slider and the connect mechanism is formed with a first snap slot, another one is formed with a first snap-fit connector matched with the first snap slot, and the second slider is detachably connected to the connect mechanism through the first snap-fit connector and the first snap slot.

10. The door body assembly of claim 9, wherein the second slider is formed with the first slot; and
the connect mechanism comprises:
a fix plate, connected to the door panel, and the fix plate is formed with a mounting slot; and
a connect block, slidably provided at the mounting slot, and the connect block is formed with the first snap-fit connector to adjust a relative position between the door panel and the box door by adjusting a position of the connect block in the mounting slot.

11. The door body assembly of claim 9, wherein the door body assembly further comprises a guide mechanism; and
the guide mechanism comprises a guide pedestal and a third slider, wherein the guide pedestal is provided at the box door, the guide pedestal is formed with a third guide rail, the third slider is slidably provided at the third guide rail, and the third slider is connected to the door panel.

12. The door body assembly of claim 11, wherein a plurality of the connect mechanisms are provided, one of the third slider and one of the plurality of connection mechanisms is formed with a second snap slot, another one of the third slider and the connection mechanism is formed with a second snap-fit connector matched with the second snap slot, and the third slider is detachably connected to the connect mechanism through the second snap-fit connector and the second snap slot.

13. The door body assembly of claim 11, wherein the box door is provided with a first mounting slot matched with the transmission mechanism, and the transmission mechanism is mounted in the first mounting slot;
and/or, the box door is provided with a second mounting slot matched with the guide mechanism, and the guide mechanism is mounted in the second mounting slot.

14. The door body assembly of claim 3, wherein the transmission mechanism further comprises: a first shaft and a second shaft;
the transmission component includes a transmission belt, wherein the transmission belt is sleeved at the first shaft and the second shaft, and the transmission belt comprises an upper belt located at a side of the first shaft and the second shaft and a lower belt located at another side of the first shaft and the second shaft, and wherein the driver is provided at the upper belt, and the driven component is provided at the lower belt.

15. The door body assembly of claim 14, wherein the door body assembly comprises:
a stroke adjuster, configured to make a stroke of the driver at the upper belt different from a stroke of the driven component at the lower belt.

16. The door body assembly of claim 3, wherein the driver comprises a first rack, the driven component comprises a second rack, and the transmission component comprises a transmission gear;
the first rack is in transmission connection with the box door, the second rack is connected to the door panel, and the transmission gear is provided between the first rack and the second rack, wherein the transmission gear meshes with the first rack and the second rack, and when the box door drives the first rack to move, the second rack drives the door panel to move in an opposite direction.

17. A refrigeration device, comprising:
a box body, formed with a storage space; and
the door body assembly of claim 1, and the box door is rotatably connected to the box body, and is configured to open or close a storage space of the box body.

18. The door body assembly of claim 1, wherein
the door body assembly and the appliance main body are used to be mounted in a cabinet body; during opening or closing of the box door, the transmission mechanism is configured to drive the door panel to move a preset distance at the box door, and the door panel avoids a side wall of the cabinet body.
